(19) United States
(12) Patent Application Publication
(10) Pub. No.: US 2003/0177793 A1
(43) Pub. Date: Sep. 25, 2003

(54) Bushing for drawing glass fibers

(75) Inventors: Wulf Kock, Alzenau (DE); David Lupton, Gelnhausen (DE); Oliver Warkentin, Darmstadt (DE)

Correspondence Address: OSTROLENK FABER GERB & SOFFEN, 1180 AVENUE OF THE AMERICAS, NEW YORK, NY, 100368403

(73) Assignee: W. C. HERAEUS & CO. KG

(21) Appl. No.: 10/350,684

(22) Filed: Jan. 24, 2003

(30) Foreign Application Priority Data
Jan. 28, 2002 (DE) 102 03 418.4-45

(51) Int. Cl. C03B 37/095

(52) U.S. Cl. 65/384; 65/493

(57) ABSTRACT

A bushing for drawing glass fibers and its use. The bushing is made of at least two different metallic materials from the group comprising platinum, platinum-iridium alloy, platinum-ruthenium alloy, and platinum-rhodium alloy, such that

′;(a) the sidewalls are made of platinum or platinum-iridium alloy or platinum-ruthenium alloy or platinum-rhodium alloy,

(b) the tip(s) are made of platinum or platinum-rhodium alloy,

(c) the power supply terminals are made of platinum or platinum-rhodium alloy, and

(d) the tip plate is made of platinum-iridium alloy or platinum-ruthenium alloy or platinum-rhodium alloy. If the sidewalls and the tip plate are made of platinum-iridium or platinum-ruthenium alloy, they have a coating of platinum or platinum-rhodium alloy at least on their exterior surface.

### BACKGROUND OF THE INVENTION

The invention concerns a bushing for drawing glass fibers, in which the bushing has a tip plate and sidewalls that form the interior space of the bushing. At least two power supply terminals are located on the exterior of the sidewalls. The tip plate has at least one orifice that opens into a tip on the exterior side of the tip plate. The invention also concerns uses of this bushing.

Bushings made of refractory noble metal alloys for drawing glass fibers are already well known. A bushing is a structure similar to a box or a housing, whose base wall has orifices, each of which opens into a tip, through which the molten glass emerges and is drawn into individual fibers. The bushing is usually provided with power supply terminals, which supply the walls of the bushing with electric current, so that the bushing is heated by its own electrical resistance. To allow systematic adjustment of the temperature in individual regions of the bushing, the thickness of individual regions of the walls is usually varied, so that the amount of current flowing through them can be adjusted and controlled. In this regard, in order to produce the desired heat distribution in the bushing and to reduce the amount of noble metal that is needed, the base wall, which holds the tips, is usually of uniform thickness, while the sidewalls are not as thick.

DE-OS 24 35 019 discloses a bushing made of platinum, rhodium, or other noble metals and their alloys, in which the sidewalls and the base of the bushing are constructed as a single piece. In addition, various processes are disclosed for processing glass to form continuous glass filaments or fibers. One such process reveals the possibility of heating the glass in furnaces, fining it in a fining chamber, and forming it into spherical bodies or marbles. The glass marbles are then fed to a feeder or a bushing, which is electrically heated, and the glass is melted to a viscosity that makes it possible to draw it into filaments through the tips. Another process disclosed here is the direct-melt process, in which a glass batch is melted in a furnace and fined. The molten glass is conveyed through channels to individual bushings, which are heated by electrical resistance heating. The glass filaments are drawn by the tips of the bushing.

WO 93/16,008 discloses a bushing that is constructed of platinum plates with different thicknesses.

DE-OS 27 00 430 discloses a platinum-rhodium alloy for bushings for producing glass fibers. In addition to rhodium, platinum, and boron, this alloy contains zirconium and/or hafnium and/or magnesium, or at least one of the elements yttrium, lanthanum, titanium, niobium, or tantalum.

JP 11[1999]-172,349 (Derwent Data Base summary) discloses a ternary alloy of platinum, rhodium, and ruthenium for making bushings for glass filament drawing processes.

U.S. Pat. No. 5,879,427 discloses a system with a bushing for drawing glass fibers, in which the bushing is made of platinum or a platinum alloy.

U.S. Pat. No. 5,110,333 describes a system with a bushing for drawing glass fibers. The bushing is made of platinum or a platinum alloy and is heated by ceramic heating units with resistance heating elements.

U.S. Pat. No. 5,749,933 discloses a system for drawing glass fibers and the use of platinum-rhodium alloys for bushings. It also discloses the use of a palladium-iridium alloy or a palladium-nickel alloy for a cooling system located below the bottom wall of the bushing.

The use of oxide-dispersion-strengthened platinum alloys for bushings is known from the article “New Platinum Materials for High-Temperature Applications” (Advanced Engineering Materials, 2001, 3, No. 10, pp. 811-820, by B. Fischer). Oxide-dispersion-strengthened, unalloyed platinum and oxide-dispersion-strengthened platinum-rhodium alloys and platinum-gold alloys are disclosed as materials for this application.

The article “High-Temperature Mechanical Properties of the Platinum Group Metals” (Platin Metals Rev., 1999, 32 (1), pp. 18-28, by B. Fischer, A. Behrends, D. Freund, D. Lupton, and J. Merker) discloses the use of platinum or platinum alloys for bushings in the glass fiber drawing process. The article investigates the creep resistance of various platinum alloys, such as platinum-iridium, platinum-rhodium, and platinum-gold, some of which are dispersion-strengthened with oxides.

The article “Finite Element Modelling of Strains and Stresses in Platinum Alloy Bushings for Textile Glass Fiber Production” (Glass Science and Technology, Glastechnische Berichte, Issue 5/2001, Vol. 74, by R. Völkl, B. Fischer, R. Teschner, and D. Lupton) discusses studies on strains and stresses in platinum alloy bushings for producing textile glass fibers. The article deals especially with an oxide-dispersion-strengthened platinum alloy with 10% rhodium made by W. C. Heraeus, Hanau (Germany).

In previously known bushings, the mechanical stiffness of the tip plate is an extremely important consideration, since the fiber drawing process can proceed effectively and with qualitative uniformity only if the tip plate is flat and horizontal. Due to the considerable mechanical and thermal stresses acting on the tip plate, it tends to experience creep in the course of the fiber drawing process. Under normal glass fiber drawing conditions, this deformation is the most frequent case of operational failure of bushings. Various structural measures are known for reducing sagging of the tip plate or for preventing it for as long as possible, such as the use of braces in or on the bushing. In this way, some of the mechanical stress can be transferred to an intermediate bottom or a perforated plate mounted above the tip plate.

### SUMMARY OF THE INVENTION

The goal of the invention is to increase the creep strength of the tip plate and at the same time ensure a high degree of chemical resistance of the bushing. In addition, the bushing as a whole should be made from the fewest possible different noble metals, so that the refining of the bushing after its use can be kept simple. Furthermore, uses of these types of bushings are to be specified.

The goal with respect to the bushing is achieved by producing the bushing from at least two different metallic materials from the group comprising platinum, platinum-iridium alloy, platinum-ruthenium alloy, and platinum-rhodium alloy, such that

(a) the sidewalls are made of platinum or platinum-iridium alloy or platinum-ruthenium alloy or platinum-rhodium alloy,

(b) the tip(s) are made of platinum or platinum-rhodium alloy,

(c) the power supply terminals are made of platinum or platinum-rhodium alloy, and

(d) the tip plate is made of platinum-iridium alloy or platinum-ruthenium alloy or platinum-rhodium alloy,

and such that, if the sidewalls and the tip plate are made of platinum-iridium or platinum-ruthenium alloy, they have a coating of platinum or platinum-rhodium alloy at least on their exterior surface.

One of the advantages of the bushing of the invention is that, due to the use of different materials, the bushing can be partially reinforced in the places that are subject to especially great mechanical stress. This means especially the tip plate. Furthermore, the wall thicknesses of the bushing can be minimized according to the creep resistance and electrical resistivity of the selected material. The use of a material with a higher electrical resistivity results in an increase in the voltage in this region of the bushing and in a lower current requirement for heating the bushing (Ohm's law). Due to the lower current requirement, the current can be supplied to the walls of the bushing through a smaller cross section of the power supply terminals. Due to the possible minimization of the wall thicknesses, the noble metal costs for a bushing in accordance with the invention can be advantageously reduced. The power supply terminals on the sidewalls of the bushing are provided for supplying heating current.

For the bushing of the invention, it was found to be advantageous for a perforated plate that contains at least one hole and completely covers the open cross section of the bushing to be installed on the side of the bushing opposite the tip plate and for the perforated plate to be made of platinum, platinum-iridium alloy, platinum-ruthenium alloy, or platinum-rhodium alloy.

Designs of the bushing that contain a total of only two different noble metals in the materials that are used were found to be especially advantageous, since these materials can be refined or recycled in an especially economical and cost-effective manner. Any oxide-ceramic components that may be present in the materials that are used do not interfere with the refining.

In this type of preferred bushing, the sidewalls, the power supply terminals and the tip(s) are made of platinum, the tip plate is made of platinum-iridium alloy or platinum-ruthenium alloy, and the coating of the tip plate is made of platinum.

In a further preferred bushing, the sidewalls, the power supply terminals, and the tip(s) are made of platinum, the tip plate and the perforated plate are made of platinum-iridium alloy, and the coating of the tip plate is made of platinum.

In another preferred bushing, the sidewalls, the power supply terminals, and the tip(s) are made of platinum, the tip plate and the perforated plate are made of platinum-ruthenium alloy, and the coating of the tip plate is made of platinum.

In another preferred bushing, the power supply terminals are made of platinum, and the sidewalls, the tip(s), the tip plate, and the perforated plate are made of platinum-rhodium alloy.

For many glass melts, however, it may be necessary to alter the wetting behavior of the tip(s). In this case, the idea of recycling becomes less important than the proper functioning of the bushing, and a total of more than two different noble metals is used. In a preferred bushing of this type, the sidewalls are made of platinum or platinum-rhodium alloy, the tip(s) are made of platinum-rhodium alloy, the tip plate is made of platinum-iridium alloy or platinum-ruthenium alloy, and the coating of the tip plate is made of platinum or platinum-rhodium alloy.

In still another preferred bushing of this type, the sidewalls are made of platinum or platinum-rhodium alloy, the tip(s) are made of platinum-rhodium alloy, the tip plate and the perforated plate are made of platinum-iridium alloy, and the coating of the tip plate is made of platinum or platinum-rhodium alloy.

In another preferred bushing, the sidewalls are made of platinum or platinum-rhodium alloy, the tip(s) are made of platinum-rhodium alloy, the tip plate and the perforated plate are made of platinum-ruthenium alloy, and the coating of the tip plate is made of platinum or platinum-rhodium alloy.

The selection of a platinum-iridium alloy or a platinum-ruthenium alloy for the tip plate and/or the perforated plate is optimum and partially increases the stiffness precisely in the critically stressed regions of the bushing, because these alloys have higher creep resistance values than unalloyed platinum.

It is also advantageous that the platinum-iridium alloys and the platinum-ruthenium alloys have a higher electrical resistivity than platinum or platinum that has been dispersion-strengthened with an oxide (see Table 1). In this way, favorable combination and selection of the materials for the bushing can be used to control and even out the distribution of the heating current in the bushing to a considerable extent. In particular, the components of the bushing that must make a considerable contribution to the overall heating efficiency of the bushing, such as the tip plate and possibly the perforated plate, are therefore preferably made of a platinum-iridium or platinum-ruthenium alloy (coated with platinum where necessary).

TABLE 1
COMPARISON OF THE ELECTRICAL RESISTIVITIES OF
PLATINUM AND PLATINUM-IRIDIUM, PLATINUM-RUTHENIUM,
AND PLATINUM-RHODIUM ALLOYS.

| | Electrical Resistivity in Ω-mm²/m | |
|---|---|---|
| Material | at room temperature | at 1,250° C. |
| Platinum (technical | 0.107 | ca. 0.45 |
| purity) | | |
| Platinum, oxide-dispersion- | 0.11 | — |
| Strengthened (type: | | |
| Pt DPH, W. C. Heraeus GmbH) | | |
| PtIr20 | 0.31 | — |
| (80 wt-% Pt, 20 wt-% Ir) | | |
| PtIr30 | 0.34 | ca. 0.64 |
| (70 wt-% Pt, 30 wt-% Ir) | | |
| PtRu5 | 0.33 | — |
| (95 wt-% Pt, 5 wt-% Ru) | | |
| PtRu10 | 0.42 | — |
| (90 wt-% Pt, 10 wt-% Ru) | | |
| PtRh10 | 0.20 | ca. 0.53 |
| (90 wt-% Pt, 10 wt-% Rh) | | |
| PtRh20 | 0.21 | — |
| (80 wt-% Pt, 20 wt-% Rh) | | |

The at least partial coating of the platinum-iridium alloy or the platinum-ruthenium alloy with platinum or platinum-rhodium alloy makes it possible to protect the given alloy from a gas atmosphere that contains oxygen. Uncoated zones should be in contact only with molten glass or with platinum or platinum-rhodium alloy to prevent iridium or ruthenium from oxidizing and vaporizing, since this would lead to pore formation in the alloy material, which in turn would reduce the strength and creep resistance of the material.

In many applications, it is advantageous to interpose an oxide-ceramic intermediate layer between the coating and the platinum-iridium or platinum-ruthenium alloy. This prevents diffusion of iridium or ruthenium through the coating. The oxide-ceramic intermediate layer may be porous or dense, since it is intended to act only as a spacing material between the platinum-iridium or platinum-ruthenium alloy and the coating.

It is especially advantageous if the platinum and/or the platinum-iridium alloy and/or the platinum-ruthenium alloy and/or the platinum-rhodium alloy is dispersion-strengthened with an oxide. This further increases the creep resistance of the materials. It was found to be especially effective to make the power supply terminals for a bushing of the invention from platinum that had been dispersion-strengthened with an oxide. For further information on the subject of oxide dispersion-strengthening, see especially German Patent DE 198 13 988 C1 and the prior art cited there.

It was found to be useful to provide the sidewalls of the bushing with a flange around the bushing at the opposite end of the sidewalls from the tip plate. It is preferably made of platinum, platinum-iridium alloy, platinum-ruthenium alloy, or platinum-rhodium alloy. If the flange is made of platinum-iridium alloy or platinum-ruthenium alloy, it has a coating of platinum or platinum-rhodium alloy. It is especially advantageous if the flange is dispersion-strengthened with an oxide. The flange is preferably made of the same material as the sidewalls.

It was also found to be advantageous for the bushing to have a rectangular cross section with four sidewalls.

In the case of a rectangular bushing, it was found to be advantageous to provide at least one power supply terminal on each of two opposite sidewalls of the four-sided bushing. It is also advantageous for the power supply terminals to be made of platinum that has been dispersion-strengthened with an oxide.

Furthermore, in the case of a rectangular bushing, it is advantageous for the two opposite sidewalls of the four-sided bushing that are provided with power supply terminals to be made of platinum that has been dispersion-strengthened with an oxide.

In a number of glass fiber drawing processes, it was found to be advantageous for the bushing to have a tank on the side of the bushing opposite the tip plate, such that the interior of the tank is connected with the interior of the bushing.

To stabilize the bushing, it was found to be advantageous to install at least one tank bracing element inside the tank to stabilize the geometry of the tank. In this regard, it is advantageous if the one or more tank bracing elements are made of platinum, platinum-rhodium alloy, platinum-iridium alloy, platinum-iridium alloy with a coating of platinum, platinum-iridium alloy with a coating of platinum-rhodium alloy, platinum-ruthenium alloy, platinum-ruthenium alloy with a coating of platinum, or platinum-ruthenium alloy with a coating of platinum-rhodium alloy. The choice of material depends, on the one hand, on whether or not the tank bracing element is covered with molten glass, and, on the other hand, on the gas atmosphere present in the tank. If the tank bracing element is not covered with molten glass or is only partially covered with molten glass, and if, for example, the gas atmosphere is air, then platinum, a platinum-rhodium alloy, a platinum-iridium alloy with a coating, or a platinum-ruthenium alloy with a coating should be selected as the material to prevent vaporization of the iridium or ruthenium. On the other hand, if the tank bracing element is completely covered with molten glass, or if it is not covered with molten glass or is only partially covered with molten glass, but at the same time the gas atmosphere contains no oxygen, then it is also possible to select an uncoated platinum-iridium alloy or an uncoated platinum-ruthenium alloy as the material.

In many applications, it is also advantageous in this case to interpose an oxide-ceramic intermediate layer between the coating and the platinum-iridium or platinum-ruthenium alloy. As was noted earlier, this prevents diffusion of iridium or ruthenium through the coating.

In addition, it is advantageous to install at least one bushing bracing element in the interior space of the bushing to stabilize the geometry of the bushing. In this regard, it was found to be especially effective for the one or more bushing bracing elements to be made of platinum, platinum-rhodium alloy, platinum-iridium alloy, platinum-iridium alloy with a coating of platinum, platinum-iridium alloy with a coating of platinum-rhodium alloy, platinum-ruthenium alloy, platinum-ruthenium alloy with a coating of platinum, or platinum-ruthenium alloy with a coating of platinum-rhodium alloy. In this case, the same criteria are used to select the materials as are used to select the materials for the tank bracing elements.

In many applications, it is also advantageous in this case to interpose an oxide-ceramic intermediate layer between the coating and the platinum-iridium or platinum-ruthenium alloy. As was noted earlier, this prevents the diffusion of iridium or ruthenium through the coating.

In this regard, it is advantageous, especially with respect to increasing the geometric stability of the bushing, for the materials for the bracing elements to be dispersion-strengthened with an oxide.

It was also found to be effective for the tip plate to have 400 to 6,000 orifices, each of which opens into a tip.

PtIr20 (80 wt-% Pt, 20 wt-% Ir) and PtIr30 (70 wt-% Pt, 30 wt-% Ir) have been found to be especially creep-resistant platinum-iridium alloys, and PtRu5 (95 wt-% Pt, 5 wt-% Ru) and PtRu10 (90 wt-% Pt, 10 wt-% Ru) were found to be especially creep-resistant platinum-ruthenium alloys (see “High Temperature Mechanical Properties of the Platinum Group Metals,” Platin Metals Rev., 1999, 32 (1), pp. 18-28, by B. Fischer, A. Behrends, D. Freund, D. Lupton and J. Merker). PtRh10 (90 wt-% Pt, 10 wt-% Rh), PtRh20 (80 wt-% Pt, 20 wt-% Rh), and PtRh24 (76 wt-% Pt, 24 wt-% Rh) have been found to be especially creep-resistant platinum-rhodium alloys.

It has been found to be advantageous to provide the tank with a gas feed connection, which is preferably made of the same material as the tank. The interior space of the tank can be filled with an inert gas through this gas feed connection. Uncoated components made of platinum-iridium alloy or platinum-ruthenium alloy can thus be directly installed in this inert gas atmosphere without any danger of oxidation or vaporization of the iridium or ruthenium.

The coating on the platinum-iridium alloy or the platinum-ruthenium alloy is preferably formed by roll-cladding with sheet metal, diffusion welding of sheet metal, spot welding of sheet metal, thermal spraying, or electroplating. In regard to spot welding, it has been found to be effective to use a textured sheet with, for example, nipple-like projections by which the spot welding is carried out. Although the joint between the platinum-iridium or platinum-ruthenium alloy and the cladding does not cover the whole surface in this case, the diffusion of iridium or ruthenium through the cladding is nevertheless prevented.

If an oxide-ceramic intermediate layer is provided between the platinum-iridium or platinum-ruthenium alloy and the platinum coating, the coating is preferably formed by thermal spraying or by joining with sheet metal.

Either with or without a ceramic intermediate layer, the coating of the tip plate is preferably formed by sheet metal, which is joined to the outside surface of the tip plate in such a way that it is at least gas-tight with the periphery of the tip(s).

When oxide-ceramic intermediate layers are used with a sheet-metal coating on the tip plate or perforated plate and bracing elements, it is advantageous if the space between the platinum-iridium or platinum-ruthenium alloy and the sheet metal is evacuated. First of all, this prevents “sagging” of the sheet metal and ensures intimate contact between the sheet metal and the intermediate layer. In addition, the transport of iridium or ruthenium towards the coating via a gas phase is prevented.

It was found to be advantageous for the sheet metal used for the coating to have a thickness of 0.1 to 0.5 mm. With respect to the oxide-ceramic intermediate layer, a low thickness, preferably in the range of 10 to 100 μm, is sufficient, since the intermediate layer serves only as a spacing material.

Materials that have been found to be especially effective for the oxide-ceramic intermediate layer are ZrO₂ and/or Al₂O₃ and/or Y₂O₃.

On the one hand, the oxide-ceramic intermediate layer may be a self-supporting component, such as a ceramic lamina, woven ceramic fabric, nonwoven ceramic fiber mat, or ceramic foil.

On the other hand, the oxide-ceramic intermediate layer may be formed by vacuum evaporation, sputtering, thermal spraying, or the application of a ceramic paste. The intermediate layer may be applied on the platinum-iridium or platinum-ruthenium alloy or on the sheet-metal coating.

The use of bushings of the invention produced without oxide-ceramic intermediate layers is optimum for drawing glass fibers at a bushing temperature ≦1,250° C., since the diffusion of iridium or ruthenium is still so slow at these temperatures that it has no effect on the service life of the bushing.

The use of bushings of the invention produced with oxide-ceramic intermediate layers is optimum for drawing glass fibers at a bushing temperature >1,250° C., since the diffusion of iridium or ruthenium is already fast enough at this temperature that the service life of the bushing would be adversely affected without an oxide-ceramic intermediate layer.

The use of a bushing without a tank is optimum for a direct-melt operation for drawing glass fibers, in which a glass melt is fed into the bushing, the viscosity of the glass melt in the bushing is controlled and adjusted by electrical resistance heating of the bushing, and the glass melt emerges from the tip(s) and is drawn into glass fibers.

In addition, the use of a bushing with a tank has been found to be advantageous for an indirect-melt operation for drawing glass fibers, in which a glass melt is processed into granulated glass, the tank is filled with the granulated glass, the granulated glass is fed into the bushing and melted by electrical resistance heating of the bushing, the viscosity of the glass melt is controlled and adjusted, and the glass melt emerges from the tip(s) and is drawn into glass fibers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described therein.

### BRIEF DESCRIPTION OF THE DRAWINGS

The invention is illustrated by Examples 1 to 4 and by the drawings in FIGS. 1 to 10.

FIG. 1 is a side view of a bushing with a rectangular cross section;

FIG. 2 is a top view of the bushing shown in FIG. 1;

FIG. 3 shows the bushing 1 in FIG. 1 from the bottom;

FIG. 4 shows a side view of bushing 1;

FIG. 5 shows section A-A′ through bushing 1 in FIG. 1;

FIG. 6 shows section B-B′ through bushing 1 in FIG. 3;

FIG. 7 shows a possible modification of a tip plate 5 in accordance with segment C in FIG. 5;

FIG. 8 shows another possible modification of a tip plate 5 in accordance with segment C in FIG. 5;

FIG. 9 shows a glass fiber drawing machine for an indirect-melt operation; and

FIG. 10 shows a cross section of the bushing, including its suspension, from FIG. 9.

### DETAILED DESCRIPTION OF THE PREFERRED EMBODIMENTS

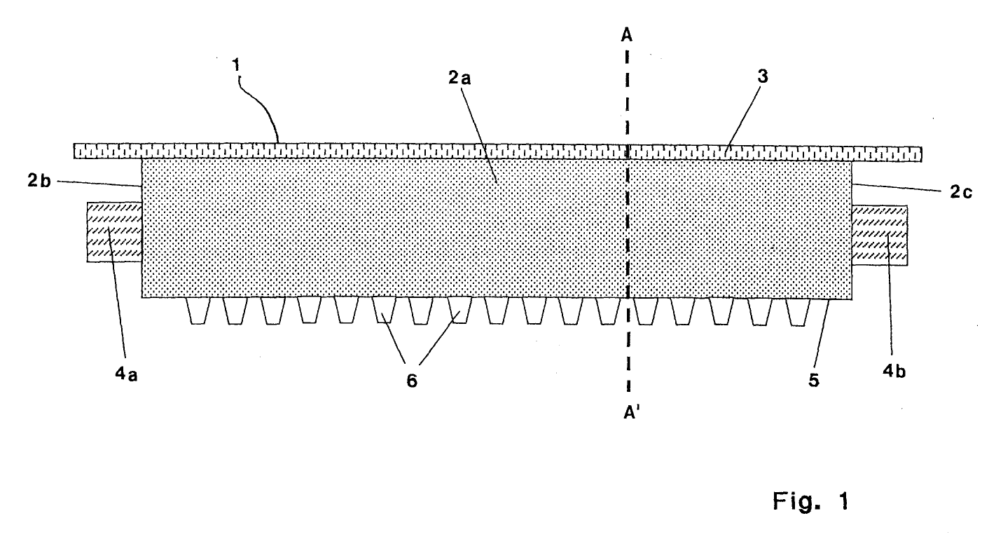

FIG. 1 is a side view of a bushing 1 with a rectangular cross section, which shows the sidewalls 2a, 2b, 2c, and a flange 3. A power supply terminal 4a is located on the sidewall 2b. Another power supply terminal 4b is located on the sidewall 2c, which is opposite the sidewall 2b. The tip plate 5 is fitted with tips 6.

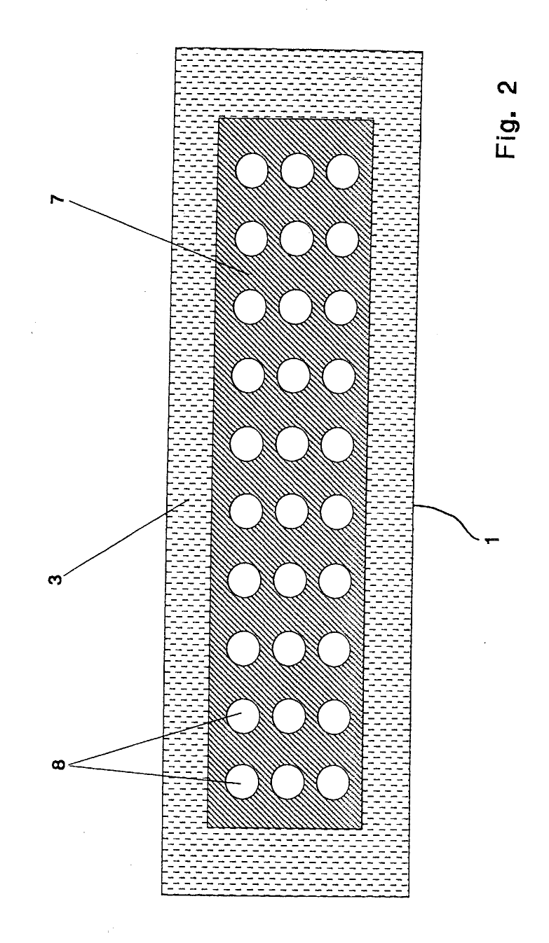

FIG. 2 is a top view of the bushing 1 of FIG. 1 and shows the flange 3 and a perforated plate 7 with plate orifices 8.

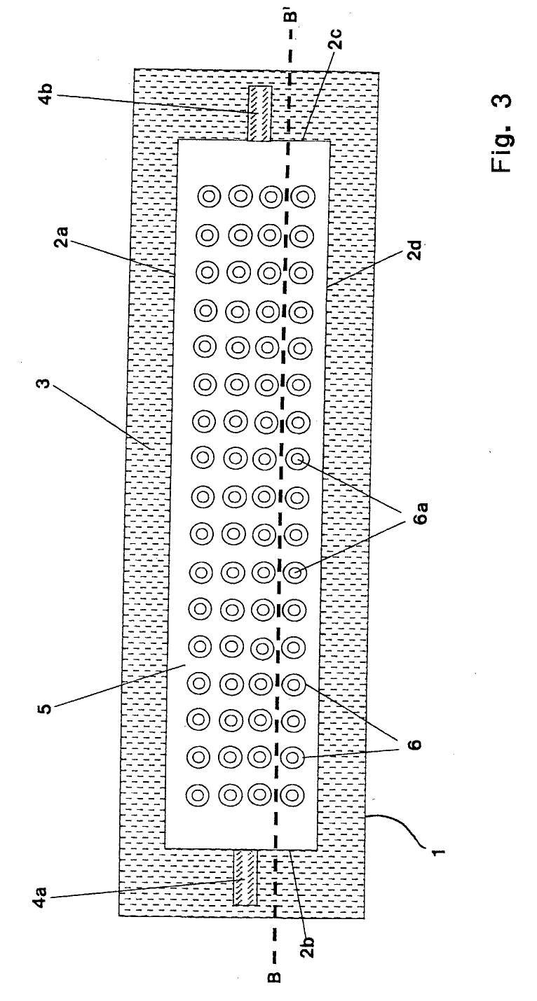

FIG. 3 is a view from the bottom of the bushing 1 of FIG. 1 and shows the flange 3, the sidewalls 2a, 2b, 2c, 2d, and the power supply terminals 4a, 4b. The tips 6 in the tip plate 5 have tip orifices 6a that are fitted to plate orifices (reference number 5a in FIGS. 5, 7, and 8) in the tip plate 5 or are used to insert the tips 6 into the tip plate.

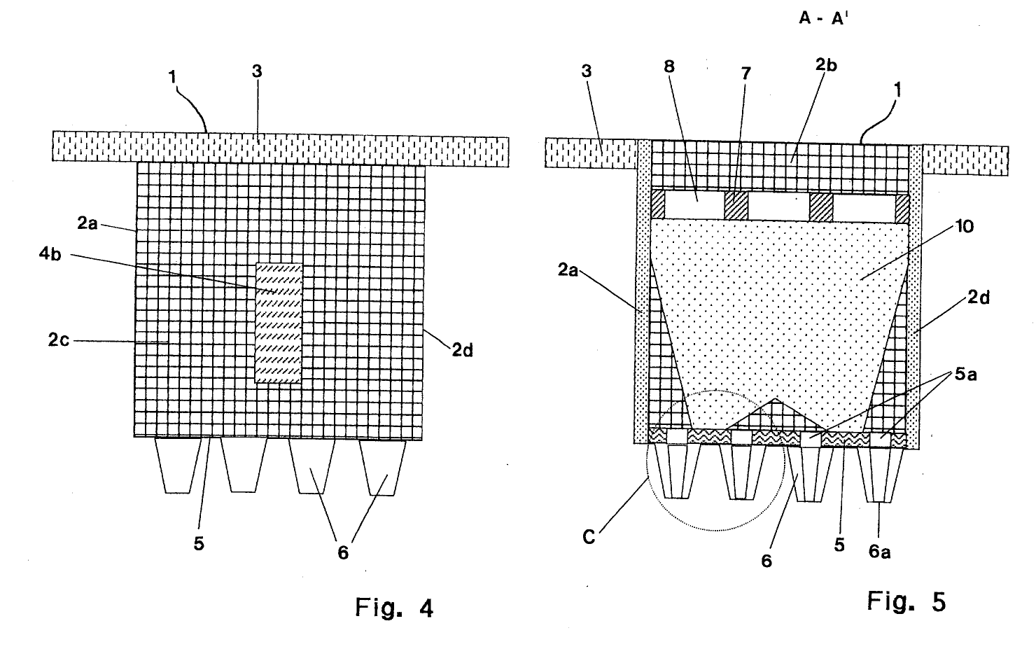

FIG. 4 is a side view of the bushing 1 with the sidewalls 2a, 2c, 2d, the flange 3, and the tip plate 5. The tips 6 and the power supply terminal 4b are also shown.

FIG. 5 shows section A-A′ through the bushing 1 in FIG. 1. The sidewalls 2a, 2b, 2d, the flange 3, and the tip plate 5 with the tip plate orifices 5a are shown. Also shown are the tips 6 with the tip orifices 6a and the perforated plate 7 with the plate orifices 8. A bushing bracing element 10 is located in the interior space of the bushing.

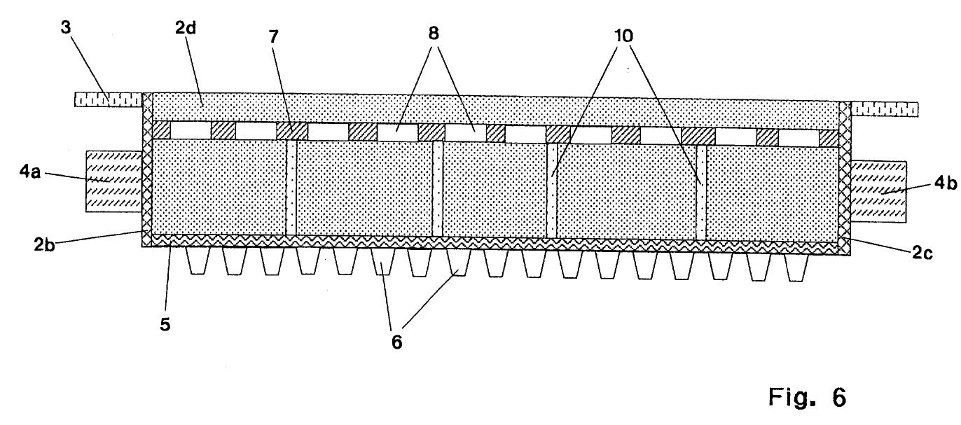

FIG. 6 shows section B-B′ through the bushing 1 in FIG. 3. Several bushing bracing elements 10 are visible.

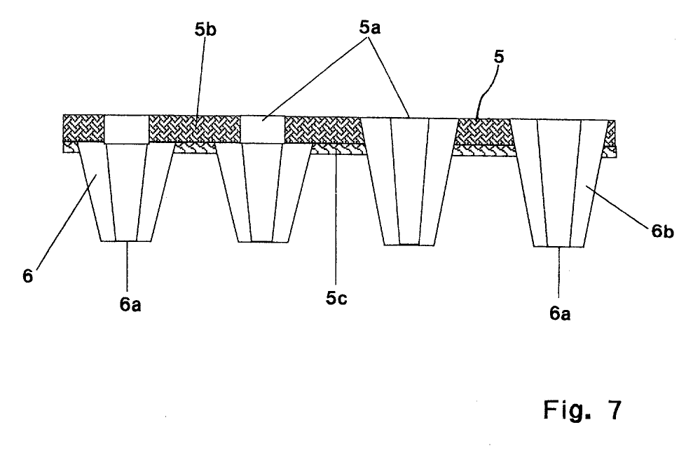

FIG. 7 shows a possible modification of a tip plate 5 in accordance with segment C in FIG. 5. The tip plate 5 consists of a plate 5b made of platinum-iridium or platinum-ruthenium alloy and a coating 5c made of platinum. Two different means of mounting the tips 6, 6b are shown. The tips 6 are mounted flush against the plate 5b and are welded with the coating 5c at their point of maximum outside diameter, so that the tip orifice 6a is directly adjacent to the plate orifice 5a. The tips 6b are inserted in the plate orifices 5a in such a way that the maximum outside diameter of each tip 6b terminates at the surface of the tip plate 5 that faces the inside of the bushing. This design of the tip plate 5 can be used up to a temperature of 1,250° C.

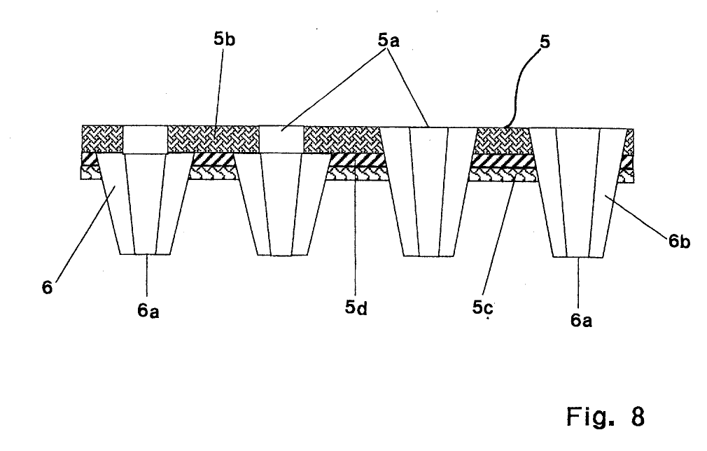

FIG. 8 shows another possible modification of a tip plate 5 in accordance with segment C in FIG. 5. The tip plate 5 consists of a plate 5b made of platinum-iridium or platinum-ruthenium alloy, a coating 5c made of platinum, and an intermediate oxide layer 5d between the plate 5b and the coating 5c. Here again, two different means of mounting the tips 6, 6b are shown. The tips 6 are mounted flush against the plate 5b and are welded with the coating 5c along their outer diameter below the intermediate layer 5d, so that the tip orifice 6a is directly adjacent to the plate orifice 5a. The tips 6b are inserted in the plate orifices 5a and joined with the plate 5b in such a way that the maximum outside diameter of each tip 6b terminates at the surface of the tip plate 5 that faces the inside of the bushing. The outside diameter of the tips 6b is welded with the coating 5c below the intermediate layer 5d. This design of the tip plate 5 is ideally used at temperatures >1,250° C.

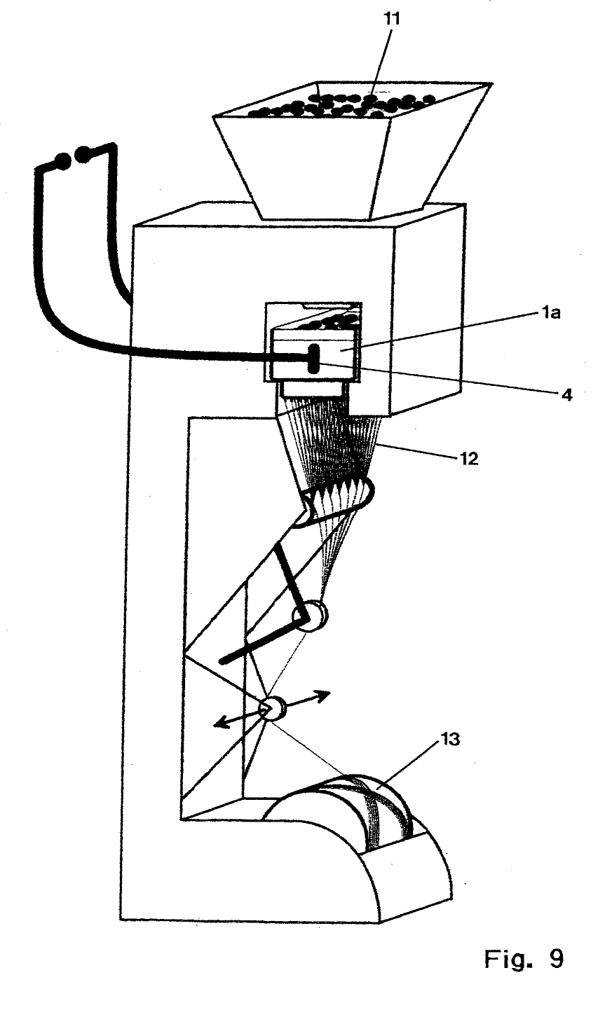

FIG. 9 shows a glass fiber drawing machine for an indirect-melt operation. Granulated glass 11 is fed into a bushing 1a, which is provided with power supply terminals 4. The glass fibers 12 drawn from the tips of the bushing 1a are spun and wound on a roll 13.

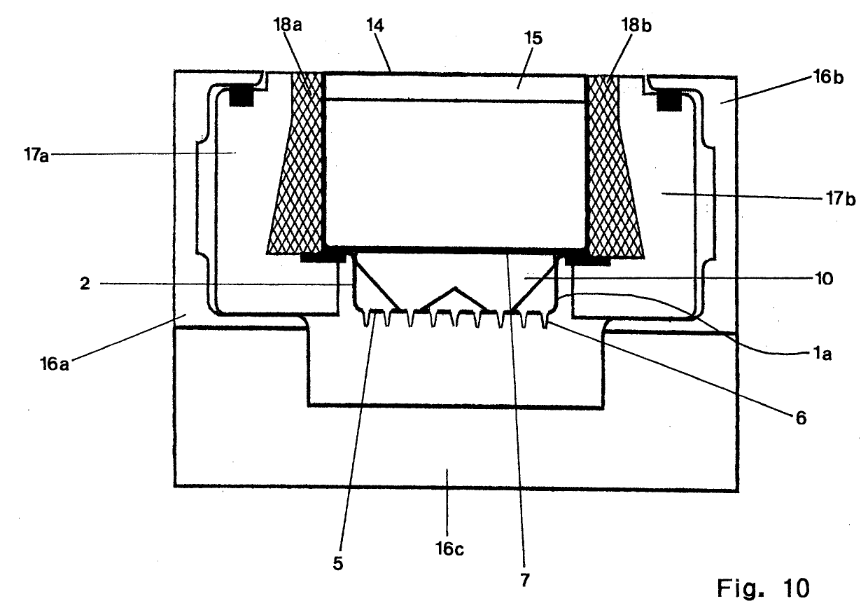

FIG. 10 is a cross section of the bushing 1a from FIG. 9 and shows a bracing element 10 inside the bushing 1a. The perforated plate 7 is located at the end of the sidewalls 2 opposite the tip plate 5, and a tank 14 is located above the perforated plate. A tank bracing element 15 is located inside the tank. The bushing 1a is mounted in a steel frame assembly 16a, 16b, 16c, from which it is thermally and electrically insulated by refractory bricks 17a, 17b and ceramic filling material 18a, 18b.

### EXAMPLE 1

The bushing 1 from FIGS. 1 to 8 is constructed with a tip plate 5, which consists of a plate 5b made of alloy PtIr30 and a platinum coating 5c on the outside surface of the tip plate 5. The coating 5c consists of a sheet of platinum 0.1 mm thick bonded to the plate 5b by roll-cladding. The sidewalls 2a, 2d, the perforated plate 7, and the tips 6, 6b are made of platinum. The sidewalls 2b, 2c, the power supply terminals 4a, 4b, and the bushing bracing elements 10 are made of oxide-dispersion-strengthened platinum. This bushing is used at temperatures up to 1,250° C.

### EXAMPLE 2

The bushing 1 from FIGS. 1 to 8 is constructed with a tip plate 5, which consists of a plate 5b made of alloy PtRu5 and a platinum coating 5c on the outside surface of the tip plate 5. Between the plate 5b and the coating Sc, there is an oxide-ceramic intermediate layer 100 μm thick, which consists of Al₂O₃. It was applied to the PtRu5 plate 5b in the form of a ceramic paste. The sidewalls 2a, 2d and the tips 6, 6b are made of platinum. The tips 6, 6b are welded gas-tight with the coating Sc at their outer diameters. The space between the plate 5b and the coating 5c, in which the oxide-ceramic intermediate layer is located, is evacuated. The sidewalls 2b, 2c, the power supply terminals 4a, 4b, and the bushing bracing elements 10 are made of oxide-dispersion-strengthened platinum. The perforated plate 7 is made of PtRu5. The perforated plate 7 is completely covered by the glass melt during the glass fiber drawing process, so a platinum coating is not necessary here. This bushing is used at temperatures above 1,250° C.

### EXAMPLE 3

The bushing 1 from FIGS. 1 to 8 is constructed with a tip plate 5, which consists of a plate 5b made of alloy PtRu10 and a coating 5c composed of oxide-dispersion-strengthened platinum on the outside surface of the tip plate 5. Between the plate 5b and the coating 5c, there is an oxide-ceramic intermediate layer in the form of a thin lamina of ZrO₂. The sidewalls 2a, 2d and the tips 6, 6b are made of platinum. The tips 6, 6b are welded gas-tight with the coating 5c at their outer diameters. The space between the plate 5b and the coating 5c, in which the oxide-ceramic intermediate layer is located, is evacuated. The sidewalls 2b, 2c and the power supply terminals 4a, 4b are made of oxide-dispersion-strengthened platinum. The perforated plate 7 and the bushing bracing elements 10 are made of PtRu10. The perforated plate 7 and the bushing bracing elements 10 are completely covered by the glass melt during the glass fiber drawing process, so a platinum coating is not necessary here. Above the perforated plate 7, there is a platinum tank 14, in which a tank bracing element 15 made of PtRu5 is mounted. This bushing is used at temperatures above 1,250° C. The tank 14 is flushed with argon through a gas feed connection to prevent vaporization of the ruthenium from the uncoated tank bracing element 15.

### EXAMPLE 4

The bushing 1 from FIGS. 1 to 8 is constructed with a tip plate 5, which consists of a plate 5b made of alloy PtIr20 and a coating 5c composed of oxide-dispersion-strengthened platinum on the outside surface of the tip plate 5. Between the plate 5b and the coating 5c, there is an oxide-ceramic intermediate layer in the form of a thin ceramic mesh of Al₂O₃. The sidewalls 2a, 2d and the tips 6, 6b are made of platinum. The tips 6, 6b are welded gas-tight with the coating 5c at their outer diameters. The space between the plate 5b and the coating 5c, in which the oxide-ceramic intermediate layer is located, is evacuated. The sidewalls 2b, 2c and the power supply terminals 4a, 4b are made of oxide-dispersion-strengthened platinum. The perforated plate 7 and the bushing bracing elements 10 are made of PtIr20. Since the perforated plate 7 and the bushing bracing elements 10 are completely covered by the glass melt during the glass fiber drawing process, they do not need to be coated with platinum. Above the perforated plate 7, there is a platinum tank 14, in which a tank bracing element 15 made of PtIr20 is mounted. The PtIr20 is coated on all sides with platinum, and an oxide-ceramic intermediate layer is present in the form of a thin ceramic mesh of Al₂O₃ between the PtIr20 and the platinum coating. The space between the PtIr20 and the coating on the tank bracing element, in which the oxide-ceramic intermediate layer is located, is evacuated. This bushing is used at temperatures above 1,250° C. The tank 14 contains granulated glass and air. Vaporization of the iridium from the tank bracing element 15 is effectively prevented by its coating.

Thus, while there have been shown and described and pointed out fundamental novel features of the present invention as applied to a preferred embodiment thereof, it will be understood that various omissions and substitutions and changes in the form and details of the devices illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

We claim:

1. A bushing for drawing glass fibers, comprising: a tip plate and sidewalls that form an interior space; and at least two power supply terminals located on an exterior of the sidewalls, the tip plate having at least one orifice that opens into a tip on an exterior side of the tip plate, the bushing being made of at least two different metallic materials from a group consisting of platinum, platinum-iridium alloy, platinum-ruthenium alloy, and platinum-rhodium alloy, such that
(a) the sidewalls are made of one of the group consisting of platinum, platinum-iridium alloy, platinum-ruthenium alloy and platinum-rhodium alloy,
(b) the tip(s) are made of one of platinum and platinum-rhodium alloy,
(c) the power supply terminals are made of one of platinum and platinum-rhodium alloy, and
(d) the tip plate is made of one of the group consisting of platinum-iridium alloy, platinum-ruthenium alloy and platinum-rhodium alloy.

2. A bushing in accordance with claim 1, wherein the sidewalls and the tip plate are made of one of platinum-iridium alloy and platinum-ruthenium alloy, the sidewalls and the tip plate having a coating of one of platinum and platinum-rhodium alloy at least on an exterior surface.

3. A bushing in accordance with claim 1, and further comprising a perforated plate that contains at least one hole and completely covers an open cross section of the bushing, the perforated plate being installed on a side of the bushing opposite the tip plate, the perforated plate being made of one of the group consisting of platinum, platinum-iridium alloy, platinum-ruthenium alloy, and platinum-rhodium alloy.

4. A bushing in accordance with claim 1, wherein the sidewalls, the power supply terminals, and the tip(s) are made of platinum, the tip plate is made of one of platinum-iridium alloy and platinum-ruthenium alloy, and the tip plate has a coating made of platinum.

5. A bushing in accordance with claim 1, wherein the sidewalls are made of one of platinum and platinum-rhodium alloy, the tip(s) are made of platinum-rhodium alloy, the tip plate is made of one of platinum-iridium alloy and platinum-ruthenium alloy, and the tip plate has a coating made of platinum or platinum-rhodium alloy.

6. A bushing in accordance with claim 3, wherein the sidewalls, the power supply terminals, and the tip(s) are made of platinum, the tip plate and the perforated plate are made of platinum-iridium alloy, and the tip plate has a coating made of platinum.

7. A bushing in accordance with claim 3, wherein the sidewalls, the power supply terminals, and the tip(s) are made of platinum, the tip plate and the perforated plate are made of platinum-ruthenium alloy, and the tip plate has a coating made of platinum.

8. A bushing in accordance with claim 3, wherein the sidewalls are made of one of platinum and platinum-rhodium alloy, the tip(s) are made of platinum-rhodium alloy, the tip plate and the perforated plate are made of platinum-iridium alloy, and the tip plate has a coating made of one of platinum and platinum-rhodium alloy.

9. A bushing in accordance with claim 3, wherein the sidewalls are made of one of platinum and platinum-rhodium alloy, the tip(s) are made of platinum-rhodium alloy, the tip plate and the perforated plate are made of platinum-ruthenium alloy, and the tip plate has a coating made of one of platinum and platinum-rhodium alloy.

10. A bushing in accordance with claim 3, wherein the power supply terminals are made of platinum, and the sidewalls, the tip(s), the tip plate, and the perforated plate are made of platinum-rhodium alloy.

11. A bushing in accordance with claim 2, and further comprising an oxide-ceramic intermediate layer interposed one of between the coating and the platinum-iridium alloy and between the coating and the platinum-ruthenium alloy.

12. A bushing in accordance with claim 1, wherein at least one of the platinum, the platinum-iridium alloy, the platinum-ruthenium alloy and the platinum-rhodium alloy is dispersion-strengthened with an oxide.

13. A bushing in accordance with claim 1, wherein the sidewalls have a flange around the bushing at an end of the sidewalls opposite the tip plate.

14. A bushing in accordance with claim 13, wherein the flange is made of one of platinum, platinum-iridium alloy, platinum-ruthenium alloy, and platinum-rhodium alloy.

15. A bushing in accordance with claim 14, wherein the flange is made of one of platinum-iridium alloy or platinum-ruthenium alloy, the flange having a coating of one of platinum and platinum-rhodium alloy.

16. A bushing in accordance with claim 14, wherein at least one of the platinum, the platinum-iridium alloy, the platinum-ruthenium alloy and the platinum-rhodium alloy is dispersion-strengthened with an oxide.

17. A bushing in accordance with claim 14, wherein the flange and the sidewalls are made of the same material.

18. A bushing in accordance with any of claim 1, wherein the bushing has a rectangular cross section with four sidewalls.

19. A bushing in accordance with claim 16, wherein at least one of the power supply terminals is arranged on each of two opposite sidewalls of the four-sided bushing.

20. A bushing in accordance with claim 19, wherein the two opposite sidewalls of the four-sided bushing are made of platinum that is dispersion-strengthened with oxide.

21. A bushing in accordance with claim 1, and further comprising a tank on a side of the bushing opposite the tip plate, an interior of the tank being connected with the interior of the bushing.

22. A bushing in accordance with claim 21, wherein at least one tank bracing element is mounted inside the tank to stabilize geometry of the tank.

23. A bushing in accordance with claim 22, wherein the at least one tank bracing element is made of one of platinum, platinum-rhodium alloy, platinum-iridium alloy, platinum-iridium alloy with a coating of platinum, platinum-iridium alloy with a coating of platinum-rhodium alloy, platinum-ruthenium alloy, platinum-ruthenium alloy with a coating of platinum, and platinum-ruthenium alloy with a coating of platinum-rhodium alloy.

24. A bushing in accordance with claim 23, wherein an oxide-ceramic intermediate layer is interposed between the coating and one of the platinum-iridium alloy and the platinum-ruthenium alloy.

25. A bushing in accordance with claim 1, and further comprising at least one bushing bracing element mounted inside the bushing to stabilize geometry of the bushing.

26. A bushing in accordance with claim 25, wherein the at least one bushing bracing element is made of one of platinum, platinum-rhodium alloy, platinum-iridium alloy, platinum-iridium alloy with a coating of platinum, platinum-iridium alloy with a coating of platinum-rhodium alloy, platinum-ruthenium alloy, platinum-ruthenium alloy with a coating of platinum, and platinum-ruthenium alloy with a coating of platinum-rhodium alloy.

27. A bushing in accordance with claim 26, wherein an oxide-ceramic intermediate layer is interposed one of between the coating and the platinum-iridium alloy and between the coating and the platinum-ruthenium alloy.

28. A bushing in accordance with claim 23, wherein at least one of the platinum, the platinum-rhodium alloy, the platinum-iridium alloy, the platinum-ruthenium alloy, and the coating is dispersion-strengthened with an oxide.

29. A bushing in accordance with claim 26 wherein at least one of the platinum, the platinum-rhodium alloy, the platinum-iridium alloy, the platinum-ruthenium alloy, and the coating is dispersion-strengthened with an oxide.

30. A bushing in accordance with claim 1, wherein the tip plate has 400 to 6,000 plate orifices, each of which opens into a tip.

31. A bushing in accordance with claim 1, wherein the platinum-iridium alloy has a composition from the group consisting of PtIr20 (80 wt-% Pt, 20 wt-% Ir) and PtIr30 (70 wt-% Pt, 30 wt-% Ir).

32. A bushing in accordance with claim 1, wherein the platinum-ruthnium alloy has a composition from the group consisting of PtRu5 (95 wt-% Pt, 5 wt-% Ru) and PtRu 10 (90 wt-% Pt, 10 wt-% Ru).

33. A bushing in accordance with claim 1, wherein the platinum-rhodium alloy has a composition from the group consisting of PtRh10 (90 wt-% Pt, 10 wt-% Rh), PtRh20 (80 wt-% Pt, 20 wt-% Rh) and PtRh24 (76 wt-% Pt, 24 wt-% Rh).

34. A bushing in accordance with claim 21, and further comprising a gas feed connection mounted on the tank.

35. A bushing in accordance with claim 34, wherein the gas feed connection is made of the same material as the tank.

36. A bushing in accordance with claim 2, wherein the coating is one of roll-clad sheet metal, diffusion welded sheet metal, spot welded sheet metal, thermal sprayed, and electroplated.

37. A bushing in accordance with claim 11, wherein the coating is formed one of by thermal spraying and by joining with sheet metal.

38. A bushing in accordance with claim 24, wherein the coating is formed one of by thermal spraying and by joining with sheet metal.

39. A bushing in accordance with claim 27, wherein the coating is formed one of by thermal spraying and by joining with sheet metal.

40. A bushing in accordance with claim 2, wherein the coating of the tip plate is sheet metal which is joined with the exterior surface of the tip plate so as to be gas-tight with a periphery of the tip(s).

41. A bushing in accordance with claim 1, wherein a space one of between the platinum-iridium alloy and the coating and between the platinum-ruthenium alloy and the coating, in which the oxide-ceramic intermediate layer is located, is evacuated.

42. A bushing in accordance with claim 24, wherein a space one of between the platinum-iridium alloy and the coating and between the platinum-ruthenium alloy and the coating, in which the oxide-ceramic intermediate layer is located, is evacuated.

43. A bushing in accordance with claim 27, wherein a space one of between the platinum-iridium alloy and the coating and between the platinum-ruthenium alloy and the coating, in which the oxide-ceramic intermediate layer is located, is evacuated.

44. A bushing in accordance with claim 36, wherein the sheet metal has a thickness of 0.1 to 0.5 mm.

45. A bushing in accordance with claim 40, wherein the sheet metal has a thickness of 0.1 to 0.5 mm.

46. A bushing in accordance with claim 11, wherein the oxide-ceramic intermediate layer has a thickness of 10-100 μm.

47. A bushing in accordance with claim 24, wherein the oxide-ceramic intermediate layer has a thickness of 10-100 μm.

48. A bushing in accordance with claim 27, wherein the oxide-ceramic intermediate layer has a thickness of 10-100 μm.

49. A bushing in accordance with claim 11, wherein the oxide-ceramic intermediate layer is made of at least one of ZrO₂, Al₂O₃ and Y₂O₃.

50. A bushing in accordance with claim 24, wherein the oxide-ceramic intermediate layer is made of at least one of ZrO₂, Al₂O₃ and Y₂O₃.

51. A bushing in accordance with claim 27, wherein the oxide-ceramic intermediate layer is made of at least one of ZrO₂, Al₂O₃ and Y₂O₃.

52. A bushing in accordance with claim 11, wherein the oxide-ceramic intermediate layer is a self-supporting component.

53. A bushing in accordance with claim 24, wherein the oxide-ceramic intermediate layer is a self-supporting component.

54. A bushing in accordance with claim 27, wherein the oxide-ceramic intermediate layer is a self-supporting component.

55. A bushing in accordance with claim 52, wherein the self-supporting component is one of the group consisting of a ceramic lamina, a woven ceramic fabric, a nonwoven ceramic fiber mat, and a ceramic foil.

56. A bushing in accordance with claim 53, wherein the self-supporting component is one of the group consisting of a ceramic lamina, a woven ceramic fabric, a nonwoven ceramic fiber mat, and a ceramic foil.

57. A bushing in accordance with claim 54, wherein the self-supporting component is one of the group consisting of a ceramic lamina, a woven ceramic fabric, a nonwoven ceramic fiber mat, and a ceramic foil.

58. A bushing in accordance with claim 11, wherein the oxide-ceramic intermediate layer is formed by one of vacuum evaporation, sputtering, thermal spraying, and an application of a ceramic paste.

59. A bushing in accordance with claim 24, wherein the oxide-ceramic intermediate layer is formed by one of vacuum evaporation, sputtering, thermal spraying, and an application of a ceramic paste.

60. A bushing in accordance with claim 27, wherein the oxide-ceramic intermediate layer is formed by one of vacuum evaporation, sputtering, thermal spraying, and an application of a ceramic paste.

61. A bushing in accordance with claim 58, wherein the intermediate layer is applied on one of the platinum-iridium alloy and the platinum-ruthenium alloy.

62. A bushing in accordance with claim 59, wherein the intermediate layer is applied on one of the platinum-iridium alloy and the platinum-ruthenium alloy.

63. A bushing in accordance with claim 60, wherein the intermediate layer is applied on one of the platinum-iridium alloy and the platinum-ruthenium alloy.

64. A bushing in accordance with claim 58, wherein the intermediate layer is applied on the coating, which consists of sheet metal.

65. A bushing in accordance with claim 59, wherein the intermediate layer is applied on the coating, which consists of sheet metal.

66. A bushing in accordance with claim 60, wherein the intermediate layer is applied on the coating, which consists of sheet metal.

67. A process for drawing glass fibers at a bushing temperature of ≦1,250° C., comprising the steps of: feeding glass to a bushing having a tip plate and sidewalls that form an interior space, and at least two power supply terminals located on an exterior of the sidewalls, the tip plate having at least one orifice that opens into a tip on an exterior side of the tip plate, the bushing being made of at least two different metallic materials from a group consisting of platinum, platinum-iridium alloy, platinum-ruthenium alloy, and platinum-rhodium alloy, such that (a) the sidewalls are made of one of the group consisting of platinum, platinum-iridium alloy, platinum-ruthenium alloy and platinum-rhodium alloy, (b) the tip(s) are made of one of platinum and platinum-rhodium alloy, (c) the power supply terminals are made of one of platinum and platinum-rhodium alloy, and (d) the tip plate is made of one of the group consisting of platinum-iridium alloy, platinum-ruthenium alloy and platinum-rhodium alloy, wherein the sidewalls, the power supply terminals, and the tip(s) are made of platinum, the tip plate is made of one of platinum-iridium alloy and platinum-ruthenium alloy, and tip plate has a coating made of platinum; and
drawing glass fibers from the tips of the bushing.

68. A process for drawing glass fibers at a bushing temperature of >1,250° C., comprising the steps of: feeding glass to a bushing having a tip plate and sidewalls that form an interior space; and at least two power supply terminals located on exterior of the sidewalls, the tip plate having at least one orifice that opens into a tip on an exterior side of the tip plate, the bushing being made of at least two different metallic materials from a group consisting of platinum, platinum-iridium alloy, platinum-ruthenium alloy, and platinum-rhodium alloy, such that (a) the sidewalls are made of one of the group consisting of platinum, platinum-iridium alloy, platinum-ruthenium alloy and platinum-rhodium alloy, (b) the tip(s) are made of one of platinum and platinum-rhodium alloy, (c) the power supply terminals are made of one of platinum and platinum-rhodium alloy, and (d) the tip plate is made of one of the group consisting of platinum-iridium alloy, platinum-ruthenium alloy and platinum-rhodium alloy, the bushing further having a perforated plate that contains at least one hole and completely covers an open cross section of the bushing installed on a side of the bushing opposite the tip plate, the perforated plate being made of one of the group consisting of platinum, platinum-iridium alloy, platinum-ruthenium alloy, and platinum-rhodium alloy, the power supply terminals are made of platinum, and the sidewalls, the tip(s), the tip plate, and the perforated plate are made of platinum-rhodium alloy; and
drawing glass fibers from the tips of the bushing.

69. A process drawing glass fibers at a bushing temperature of >1,250° C., comprising the steps of: feeding glass to a bushing having a tip plate and sidewalls that form an interior space, and at least two power supply terminals located on an exterior of the sidewalls, the tip plate having at least one orifice that opens into a tip on an exterior side of the tip plate, the bushing being made of at least two different metallic materials from a group consisting of platinum, platinum-iridium alloy, platinum-ruthenium alloy, and platinum-rhodium alloy, such that (a) the sidewalls are made of one of the group consisting of platinum, platinum-iridium alloy, platinum-ruthenium alloy and platinum-rhodium alloy, (b) the tip(s) are made of one of platinum and platinum-rhodium alloy, (c) the power supply terminals are made of one of platinum and platinum-rhodium alloy, and (d) the tip plate is made of one of the group consisting of platinum-iridium alloy, platinum-ruthenium alloy and platinum-rhodium alloy, wherein the sidewalls and the tip plate are made of one of platinum-iridium alloy and platinum-ruthenium alloy, the sidewalls and the tip plate having a coating of one of platinum and platinum-rhodium alloy at least on an exterior surface, and further comprising an oxide-ceramic intermediate layer interposed one of between the coating and the platinum-iridium alloy and between the coating and the platinum-ruthenium alloy; and drawing glass fibers from the tips of the bushing.

70. A process for drawing glass fibers in a direct-melt operation, comprising the steps of: feeding a glass melt into a bushing having a tip plate and sidewalls that form an interior space, and at least two power supply terminals located on an exterior of the sidewalls, the tip plate having at least one orifice that opens into a tip on an exterior side of the tip plate, the bushing being made of at least two different metallic materials from a group consisting of platinum, platinum-iridium alloy, platinum-ruthenium alloy, and platinum-rhodium alloy, such that (a) the sidewalls are made of one of the group consisting of platinum, platinum-iridium alloy, platinum-ruthenium alloy and platinum-rhodium alloy, (b) the tip(s) are made of one of platinum and platinum-rhodium alloy, (c) the power supply terminals are made of one of platinum and platinum-rhodium alloy, and (d) the tip plate is made of one of the group consisting of platinum-iridium alloy, platinum-ruthenium alloy and platinum-rhodium alloy;
controlling and adjusting the viscosity of the glass melt in the bushing by electrical resistance heating of the bushing; and
drawing the glass melt that emerges from the tip into glass fibers.

71. A process for drawing glass fibers in an indirect-melt operation using a bushing having a tip plate and sidewalls that form an interior space, and at least two power supply terminals located on an exterior of the sidewalls, the tip plate having at least one orifice that opens into a tip on an exterior side of the tip plate, the bushing being made of at least two different metallic materials from a group consisting of platinum, platinum-iridium alloy, platinum-ruthenium alloy, and platinum-rhodium alloy, such that (a) the sidewalls are made of one of the group consisting of platinum, platinum-iridium alloy, platinum-ruthenium alloy and platinum-rhodium alloy, (b) the tip(s) are made of one of platinum and platinum-rhodium alloy, (c) the power supply terminals are made of one of platinum and platinum-rhodium alloy, and (d) the tip plate is made of one of the group consisting of platinum-iridium alloy, platinum-ruthenium alloy and platinum-rhodium alloy, a tank being arranged on a side of the bushing opposite the tip plate, an interior of the tank being connected with the interior of the bushing, comprising the steps of: processing a glass melt into granulated glass; filling the tank with the granulated glass; feeding the granulated glass into the bushing; melting the granulated glass by electrical resistance heating of the bushing; controlling and adjusting viscosity of the glass melt; and drawing the glass melt into glass fibers as it emerges from the tip(s).
